(19) United States
(12) Patent Application Publication
(10) Pub. No.: US 2007/0073800 A1
(43) Pub. Date: Mar. 29, 2007

(54) Provisioning, configuring, and managing a platform in a network

(75) Inventors: Michael A. Rothman, Puyallup, WA (US); Vincent J. Zimmer, Federal Way, WA (US)

Correspondence Address: COURTNEY STANFORD & GREGORY LLP;C/O INTELLEVATE, P.O. BOX 52050, MINNEAPOLIS, MN, 55402, US

(73) Assignee: Intel Corporation

(21) Appl. No.: 11/238,385

(22) Filed: Sep. 29, 2005

(51) Int. Cl. G06F 15/16

(52) U.S. Cl. 709/202; 709/203

(57) ABSTRACT

Embodiments of a method and system for automatically provisioning a computing device in a network are disclosed herein. The computing device is provisioned with an agent that automatically repurposes a computing device in the computing network. In an embodiment, the agent is used to automatically provision the computing device with infrastructure, such as adding and/or updating software, configuration settings, and/or other computing functionality. The agent is also used to configure and manage the computing device. Other embodiments are described and claimed.

### BACKGROUND OF THE DISCLOSURE

In clustered, enterprise environments today, such as the high-performance computing (HPC) environments, the configuration of a set of computers is an arduous, painstaking task. For instance, to install an operating system (OS) in a number of computers requires a user, such as an administrator, to manually select an OS and boot an installation compact disc (CD) to install the OS on each computer. Once the CD is up and running, the administrator has to manually go through a series of questions, using a wizard for example, to configure the OS according to the user's preferences. Some computers can be remotely configured using a remote system, however this process also entails manual intervention. To remotely install an OS to a computer typically requires a user to manually boot some floppy disc or CD which connects the computer to some server. Once connected, a selection menu is presented to the user who can select and then download an OS image. Thereafter, the user manually proceeds through the installation to configure the OS. These configuration methods do not automatically install or configure a target computer. The manual installation process is not only inefficient, but is also costly. Moreover, it is difficult to repurpose these computer systems, since the systems are not provisioned with automatic configurability in mind.

### BRIEF DESCRIPTION OF THE DRAWINGS

FIG. 1 is a block diagram of an operating environment including one or more devices configured to automatically provision and manage a respective computing device, according to an embodiment.

FIG. 2 is a block diagram of a computing device of FIG. 1, according to an embodiment.

FIG. 3 is a flow diagram illustrating a process of configuring and managing a computing device, according to an embodiment.

FIG. 4 is a flow diagram illustrating the interaction of a remote administrator with a computing device and an agent, according to an embodiment.

FIG. 5 is a flow diagram illustrating the interaction between a remote administrator and an agent, according to an embodiment.

### DETAILED DESCRIPTION

A platform, such as server, desktop, handheld device, or other computing devices can be automatically provisioned, configured, and managed for optimal use in a computing network, under embodiments described herein. An agent is included in a computing device and operates to automatically repurpose the computing device in the computing network. The agent provides a corresponding computing device with sufficient capability to optimize the computing device for use in the computing network. The agent is used to provision, configure, and manage the computing device with infrastructure, such as adding and/or updating software, configuration settings, and/or other computing functionality. Accordingly, embodiments of a method and system for provisioning, configuring, and/or managing a computing device in a computing network are disclosed herein.

In the following description, numerous specific details are introduced to provide a thorough understanding of, and enabling description for, embodiments described herein. One skilled in the relevant art, however, will recognize that these embodiments can be practiced without one or more of the specific details, or with other components, systems, etc. In other instances, well-known structures or operations are not shown, or are not described in detail, to avoid obscuring aspects of the disclosed embodiments.

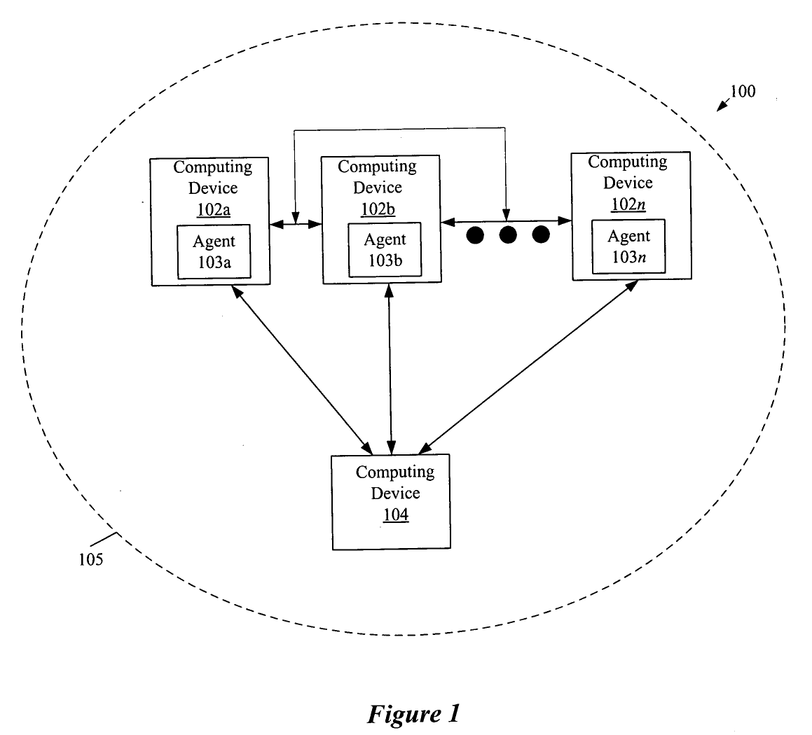

FIG. 1 illustrates an operating environment 100 including a number of computing devices 102a-102n, and 104. The computing devices 102a-102n include respective agents 103a-103n which operate to automatically communicate across a network 105 to one or more computing devices, such as computing device 104, under embodiments described herein. The agents 103a-103n can be included in the computing devices 102a-102n during manufacture. Alternatively, as described below, the agents 103a-103n are provisioned to the computing device 102a-102n by a remote administrator or other entity.

Each agent 103a-103n provides a corresponding computing device 102a-102n with sufficient capability to automatically provision and optimize the computing device 102a-102n for use in a network 105. For example, each agent 103a-103n can operate to automatically communicate across the network 105 and provision a respective computing device 102a-102n with appropriate settings, such as firmware and other configuration settings. As a further example, each agent 103a-103n can operate to automatically communicate across the network 105 and provision a respective computing device 102a-102n with an operating system (OS), such as an OS for any system environment, such as a Linux, Windows, or other system environments.

Computing device as used herein refers to any computing platform, such as a server, desktop, laptop, handheld, mobile, and other computing devices operating to transfer and manipulate information. As shown in FIG. 1, each computing device 102a-102n is in communication with computing device 104. The computing device 104 is a remote server, such as a provisioning server in a server farm, which provides provisioning and interrogation resources, as described below.

A remote administrator can use the provisioning and interrogation resources of computing device 104 to configure one or more computing devices 102a-102n in a network 105. The computing devices 102a-102n, and 104 communicate with one another and define the computing network 105. As used herein, the term “network” encompasses any configuration of computing devices which are transferring and manipulating information. The network 105 can be a local area network, wide area network, etc. and can be implemented as a wireline network, a wireless network, a combination of wireline and wireless, or any other communication medium and/or method.

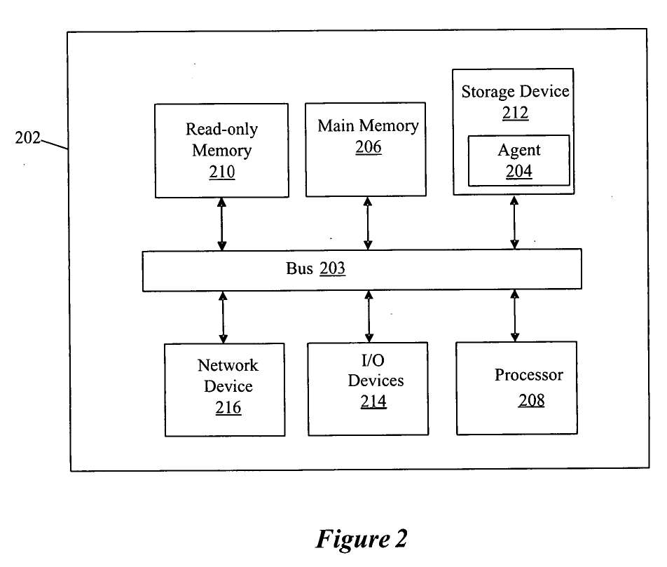

FIG. 2 illustrates a computing device 202 which includes an agent 204, under embodiments described herein. For ease of description, a single computing device 202 and associated agent 204 are described to illustrate an embodiment. As described above, the agent 204 automatically enables the respective computing device 202 to optimize its configuration and settings for use in a particular computing environment, such as network 105 of FIG. 1. The agent 204 executes without a user knowing of the execution (sometimes referred to as operating as an “out of band” agent). As described further below, the agent 204 allows a remote administrator to communicate with computing device 202 to provision settings and/or other aspects of the computing device 202.

The computing device 202 typically includes random access memory (RAM) or other dynamic storage as a main memory 206 for storing information and instructions to be executed by a processor 208. The computing device 202 can include multiple processors and other devices. The computing device 202 can include read-only memory (ROM) 210 and/or other static storage for storing static information and instructions for the processor 208.

A storage device 212, such as a magnetic disk, optical disk and drive, flash memory or other nonvolatile memory, or other memory device, can be coupled to the bus 203 of the computing device 202 for storing information and instructions. In one embodiment, the agent 204 is configured as logic embedded in the system firmware, such as storage device 212. The embedded logic can be hardware, software, or a combination of both. Firmware refers to software stored in memory, and is typically responsible for the behavior of the computing device 202 when it is first switched on. Alternatively, the agent 204 can reside in non-volatile memory, such as a flash memory component.

A number of input/output (I/O) devices 220 can be coupled with the computing device 202 via bus 203. Exemplary (I/O) devices include, but are not limited to, display devices, communication devices, audio devices, printers, scanners, and various data manipulation devices for inputting and outputting information to a platform. The computing device 202 also includes a networking device 216, such as a network card or chip, for communicating across a network. The computing device 202 can be in communication with more than one network and/or other computing device.

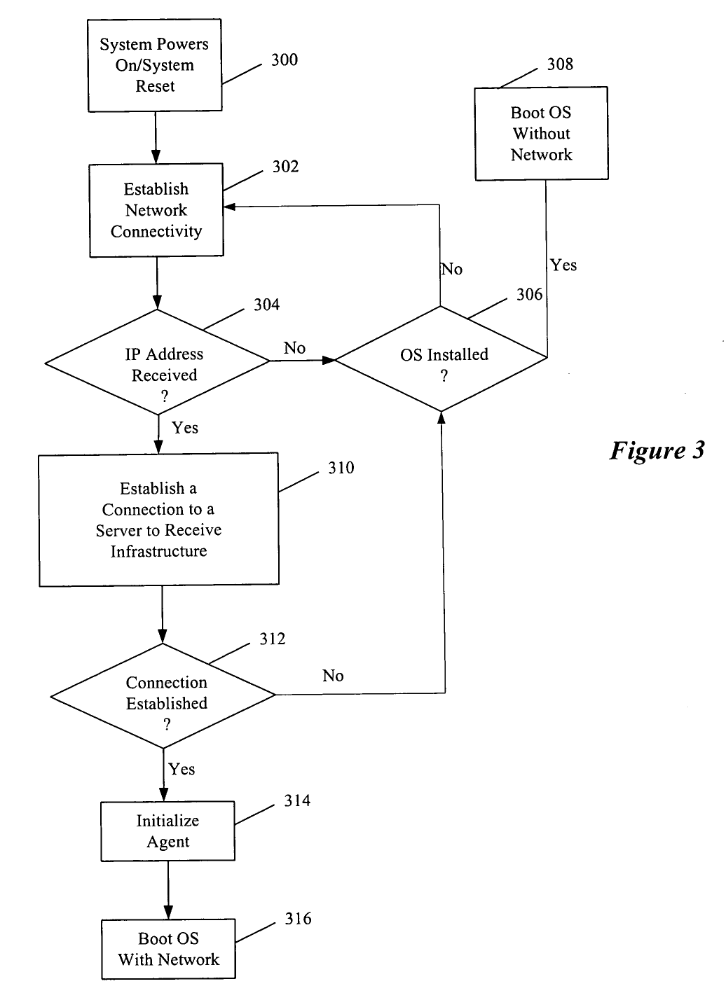

FIG. 3 is a flow diagram illustrating an automatic provisioning operation using an agent 204 according to an embodiment. As described above, the agent 204 is configured to automatically communicate across a network to provision the computing device 202 with appropriate configuration settings, software, and/or other functionality for optimal use in a network. At 300, computing device 202 powers on by switching on the computing device 202. Alternatively, as described below, at 300, the computing device 202 may have been reset by the user or the remote administrator.

According to this embodiment, the computing device 202 initially boots to a network, such as network 105, via agent 204. At 302, the agent 204 establishes a network connection using the network device 216. Alternatively, the computing device 202 is pre-provisioned with sufficient infrastructure to request that an agent 204 be provided (pushed or pulled) to the device 202. The computing device 202 establishes a network connection automatically based on the embedded firmware logic which defines certain functionality. A computing device includes an associated policy which defines how the device operates, including its initialization sequence. For example, as described below, an administrator or other user may want the computing device 202 to include certain features (i.e. the policy) which can be automatically provisioned to the device 202 using the agent 204.

At 304, the agent 204 determines whether the computing device 202 has received an internet protocol (IP) or other network address. For example, the agent 204 can issue a Dynamic Host Configuration Protocol (DHCP) or similar request to a server for an IP address. If the computing device 202 has not received an IP address, at 306, the agent 204 determines whether an operating system (OS) is currently installed. If an OS is currently installed, at 308, the OS boots without a network connection. If an OS is not currently installed, the flow returns to 302.

If the computing device 202 receives an IP address, at 310, the agent 204 establishes a communication link with a provisioning server, such as computing device 104 of FIG. 1, and can retrieve/receive additional infrastructure therefrom. According to an embodiment, the computing device 202 is pre-programmed with a list of servers, such as the provisioning server, etc., which include various features and infrastructure. Alternatively, the agent can be configured to retrieve a list of one or more provisioning servers from another computing device or store. A provisioning server includes enhanced services and other information that can be provided (pushed or pulled) to the computing device 202 based on an associated policy. For example, initially, the computing device 202 may not include an OS or certain enhanced services due to flash space or other constraints. As described below, the provisioning server can query the computing device 202 to determine its current configuration, settings, state, etc.

Continuing the example, based on the agent's response/request, the provisioning server can provide a script to the computing device 202 which enables the device 202 to download an OS image and/or other information or services. As used herein, a script is a list of commands that can be executed without the need for user interaction. Once the OS image is downloaded, the script automatically installs the OS to the target computing device 202. Thus, a remote administrator can autonomously configure a network by including and/or using an agent 204 in an associated computing device 202.

As described above, the agent 204 can be used to provision the computing device with various enhanced services and other information/operability. Some of the enhanced services include, but are not limited to: various configuration settings; an enhanced Transmission Control Protocol/Internet Protocol (TCP/IP) stack to optimize transfer rates and network interoperability; an enhanced TCP/IP stack augmented by some Transport Layer Security; agent updating or installing; a command line interface (CLI) or other interface for providing remote administration; packet transfers such as firmware updates; OS payload downloads if the system has local media and there is no OS payload ready to execute; OS payload downloads to copy to and execute from RAM; OS payload changes; and/or any other data required to optimize the operation of a computing device in a network.

As described below, a remote administrator can use the agent 204 (via CLI or other interface, for example) to interact with the computing device 202. At 312, the agent 204 determines whether a network connection is established. If a network connection is not established, the flow proceeds to 306. If a network connection is established, at 314, the agent 204 is initialized. Thereafter, at 316, the OS boots with the network 105. The computing device 202 can now be provisioned with additional infrastructure by interacting with the computing device 104.

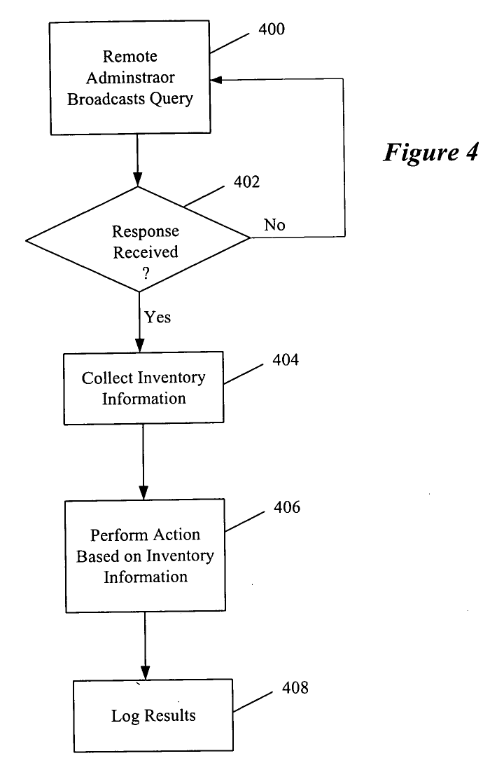

FIG. 4 is a flow diagram illustrating an interaction of a remote administrator with the computing device 202 and agent 204 of FIG. 2, according to an embodiment. For example, the agent 204 can include the functionality of a command-line interface (CLI) or similar interface which enables the remote administrator to interact with the computing device 202. At 400, the remote administrator broadcasts a query packet to a number of recipients, including computing device 202. The query packet can be a script tailored to determine the capabilities and/or limitations (the inventory) of each networked computing device. The query packet can include queries such as: type of OS; IP address; input/output device configuration; system management basic input/output system (SMBIOS) information; driver versions; status; and other information requests regarding the infrastructure and other features of the computing device 202. At 402, the remote administrator determines whether any responses have been received based on the query.

If the remote administrator has not received a response, the flow returns to 400. If the remote administrator has received a response, at 404, the remote administrator collects inventory and other data from one or more recipients based on the query. The remote administrator can target a script to a specific recipient based on the response and a set of criteria to either extract further information or possibly push information to the recipient. Thus, based on each response, at 406, the remote administrator determines whether to follow-up with a particular recipient.

For example, computing device 202 may provide inventory data to the remote administrator which includes an old firmware version. Using a CLI or other interface, the remote administrator can then instruct the computing device 202 to get an updated firmware version. The updated firmware version can also be pushed to the computing device 202. In various embodiments, the functionality of the remote administrator is automated. That is, scripts pushed or pulled down by the computing device 202 are tailored to execute and provision the device 202 with infrastructure.

As described above, using the agent 204, the remote administrator has a number of available capabilities for managing and configuring the computing device 202 which include, but are not limited to: requesting inventory information; retrieving inventory information; retrieving field replaceable unit (FRU) information, such as a chip, motherboard, or other hardware component; retrieving SMBIOS record information; ascertaining or challenging the platform-based cryptographic identity; initiating system resets; initiating system firmware updates; and initiating O/S payload updates. At 408, the remote administrator logs the query responses and any action taken. Other embodiments are within the scope of the description, and the embodiments and examples described herein are not intended to be limiting.

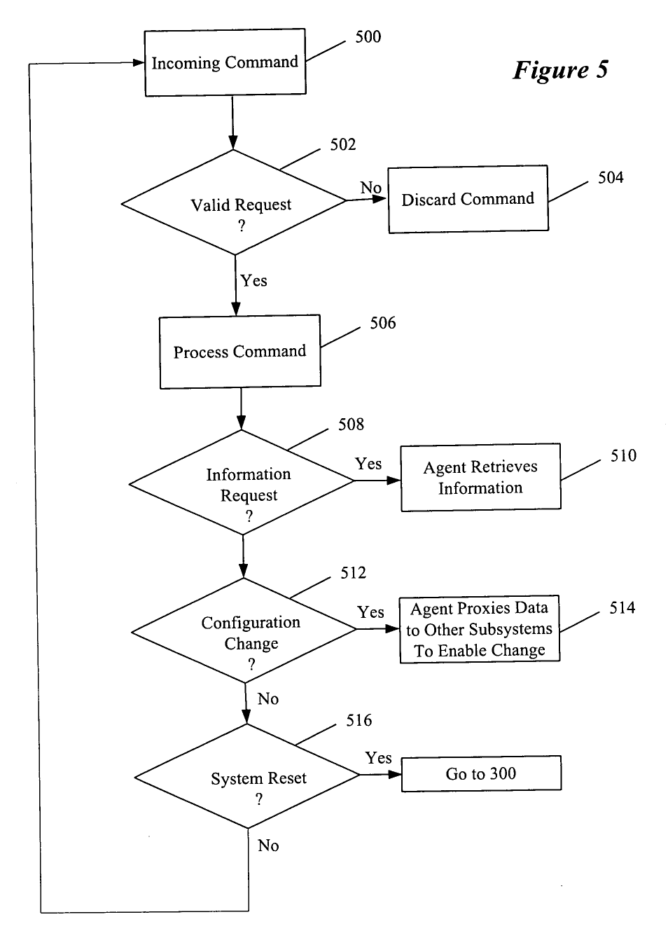

FIG. 5 is a flow diagram illustrating the interaction between a remote administrator and the agent 204 of FIG. 2, according to an embodiment. At 500, the agent 204 receives a command across a network from the remote administrator. At 502, the agent 204 determines whether the command is valid. There are numerous methods for performing the validation. For example, the agent 204 can validate the command using various password, closed network, or encryption techniques. If the agent 204 determines that the command is not valid, at 504, the agent 204 discards the command. If the agent 204 determines that command is valid, at 506, the agent 204 processes the command.

At 508, the agent 204 determines the presence and nature of the request. The request may be probing for information associated with the computing device 202. For example, the remote administrator may be requesting the current inventory, status, debug, and/or other information associated with the computing device 202. If the remote administrator is requesting information, at 510, the agent 204 retrieves and returns the information to the remote administrator. The remote administrator can use the returned information to optimize the operation of the computing device 202.

If the remote administrator is not requesting information, at 512, the agent 204 determines whether the remote administrator is requesting a configuration change. If the remote administrator is requesting a configuration change, at 514, the agent 204 proxies data to other subsystems to enable the change, such as an OS or firmware update for example. If the remote administrator is not requesting a configuration change, at 516, the agent 204 determines whether the computing device 202 has been reset. If the computing device 202 has been reset, the flow returns to 300 of FIG. 3, otherwise the flow returns to 500.

In an alternative embodiment, the agent 204 is included as part of a protected region of the computing device 202. The agent 204 executes exclusive of an OS, such as in a Secure Management Mode (SMM). Using the agent 204, a remote administrator can determine the health of a platform. Since the agent 204 resides in a protected area of a system, it is capable of surviving from the earliest system initialization to the triaging of a hung system. In fact, since the agent is in a protected region of the computing device 202, the agent 204 can be used to interrogate a system that would normally be unable to communicate due to an operating system crash or other malfunction.

For example, an administrator can determine whether the system has encountered a problem, such as critical error and/or whether the system is in a non-functional state. In this case, additional debug information can be extracted from the system to triage the cause of the failure. Once this has been done, a remote reset request can be initiated so that the system resumes an operational state. If state is maintained to determine that a reset was recently initiated and a critical error happened yet again, an alert can be initiated at the remote administrator's terminal or the information can be logged, and other policy actions might ensue. Various different implementations and configurations can be used according to a desired preference.

Aspects of the methods and systems described herein may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Embodiments may also be implemented as microcontrollers with memory (such as electrically erasable programmable read-only memory (“EEPROM”)), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. Of course the underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, etc.

The various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., hypertext transfer protocol (“HTTP”), file transfer protocol (“FTP”), simple mail transfer protocol (“SMTP”), etc.).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list; all of the items in the list; and any combination of the items in the list.

The above description of illustrated embodiments is not intended to be exhaustive or limited by the disclosure. While specific embodiments of, and examples are described herein for illustrative purposes, various equivalent modifications are possible, as those skilled in the relevant art will recognize. The teachings provided herein can be applied to other systems and methods, and not only for the systems and methods described above. The elements and acts of the various embodiments described above can be combined to provide further embodiments. These and other changes can be made to methods and systems in light of the above detailed description.

In general, in the following claims, the terms used should not be construed to be limited to the specific embodiments disclosed in the specification and the claims, but should be construed to include all systems and methods that operate under the claims. Accordingly, the method and systems are not limited by the disclosure, but instead the scope is to be determined entirely by the claims. While certain aspects are presented below in certain claim forms, the inventors contemplate the various aspects in any number of claim forms. For example, while only one aspect is recited as embodied in a machine-readable medium, other aspects may likewise be embodied in a machine-readable medium. Accordingly, the inventors reserve the right to add additional claims after filing the application to pursue such additional claim forms for other aspects as well.

What is claimed is:

1. A method comprising:
establishing communication with a computing device to a server on a network;
receiving a unique identifier from the server; and
after receiving the unique identifier from the server, applying an agent of the computing device as an interface with the server, wherein the agent resides in a protected area of the computing device and operates to provision the computing device with infrastructure from the server on the network, wherein the infrastructure includes enhanced services not initially installed on the computing device.

2. The method of claim 1, wherein the agent operates further to configure and manage the computing device by interacting with the server on the network.

3. The method of claim 1, wherein the agent operates further to provision the computing device with an operating system (OS) after establishing a network connection.

4. The method of claim 3, further comprising installing the OS on the computing device.

5. The method of claim 1, wherein the agent operates further to determine an inventory of the computing device.

6. The method of claim 5, wherein the agent operates further to provision the enhanced services to the computing device from the server on the network based at least in part on the inventory determination.

7. The method of claim 6, wherein the enhanced services are associated with a policy of the computing device.

8. A computer-readable medium having stored thereon instructions, which when executed in a system operate to:
establish communication with a computing device to a server on a network;
receive a unique identifier from the server; and
after receiving the unique identifier from the server, apply an agent of the computing device as an interface with the server, wherein the agent resides in a protected area of the computing device and operates to provision the computing device with infrastructure from the server on the network, wherein the infrastructure includes enhanced services not initially installed on the computing device.

9. The medium of claim 8, wherein the instructions, when executed, apply the agent to configure and manage the computing device by interacting with the server on the network.

10. The medium of claim 8, wherein the instructions, when executed, apply the agent to provision the computing device with an operating system (OS) from the server on the network.

11. The medium of claim 10, wherein the instructions, when executed, install the OS on the computing device.

12. The medium of claim 8, wherein the instructions, when executed, apply the agent to determine an inventory of the computing device.

13. The medium of claim 12, wherein the instructions, when executed, apply the agent to provision the enhanced services to the computing device from the server on the network based at least in part on the inventory determination.

14. The medium of claim 13, wherein the instructions, when executed, apply the agent to provision the enhanced services according to a policy of the computing device.

15. A system comprising:
a computing device in a network including an agent residing in a protected region of the computing device, wherein the agent operates to,
establish communication with a server on a network;
receive a unique identifier from the server; and
after receiving the unique identifier from the server, provide an interface with the server and provision the computing device with infrastructure from the server on the network, wherein the infrastructure includes enhanced services not initially installed on the computing device.

16. The system of claim 15, wherein the agent operates further to provision the computing device with an operating system (OS).

17. The system of claim 15, wherein the agent operates further to determine an inventory of the computing device.

18. The system of claim 17, wherein the agent operates further to provision the enhanced services to the computing device from the server on the network based at least in part on the on the inventory determination.

19. The system of claim 18, wherein the agent operates to provision the enhanced services according to a policy of the computing device.

20. The system of claim 15, wherein the agent operates to configure and manage the computing device by interacting with the server on the network.
